(19) United States
(12) Patent Application Publication
(10) Pub. No.: US 2023/0357058 A1
(43) Pub. Date: Nov. 9, 2023

(54) SYSTEM AND METHOD FOR REMOVING CARBON DIOXIDE FROM SEA WATER

(71) Applicant: Yale University, New Haven, CT (US)

(72) Inventors: Shu Hu, New Haven, CT (US); Atsu Kludze, New Haven, CT (US); Marcelo Lejeune, New Haven, CT (US)

(21) Appl. No.: 18/312,793

(22) Filed: May 5, 2023

Related U.S. Application Data
(60) Provisional application No. 63/338,569, filed on May 5, 2022.

(51) Int. Cl. C02F 3/12; C02F 1/469; B01D 61/44; B01D 61/46

(52) U.S. Cl. CPC C02F 1/4693; B01D 61/445; B01D 61/464; C02F 3/1205; C02F 2103/08

(57) ABSTRACT

Disclosed herein is a system for removing carbon dioxide (CO₂) from seawater including an electrodialysis flow cell comprising a bipolar membrane having an acidified seawater product stream with a pH less than or equal to 8.5 and a basified seawater product stream with a pH greater than or equal to 9.0; a photobioreactor; and a microbially induced carbonate precipitation component; wherein the electrodialysis flow cell is in fluid communication with the photobioreactor via the acidified seawater product stream and in fluid communication with the microbially induced carbonate precipitation component via the basified seawater product stream.

### CROSS REFERENCE TO RELATED APPLICATIONS

This application claims priority under 35 U.S.C. §119(e) to U.S. Provisional Pat. Application No. 63/338,569, filed on May 5, 2022, the contents of which are hereby incorporated by reference in their entirety.

### BACKGROUND OF THE INVENTION

Increasing atmospheric CO₂ levels have led to an increased greenhouse effect, rising global temperatures, and more extreme weather patterns. (Fischer, et al., Nature Climate Change, 2021) As of August 2021, the atmospheric concentration of CO₂ has reached 418 ppm, a greater than 10% increase since the start of the century. In order to reach the goals set by the Paris Agreement to curtail anthropogenic temperature rise to 1.5-2° C., negative emissions technologies (NET) are necessary during the transition from fossil fuels to sustainable energy and chemical production sources. (National Academies of Sciences, E. and Medicine, Negative Emissions Technologies and Reliable Sequestration: A Research Agenda, 510) Thus, there is an ever growing need to explore CO₂ capture and conversion methods that are not only efficient, but economically viable. (Hepburn, et al., Nature, 2019. 575(7781): p. 87-97)

Owing to its large surface area and salinity, the ocean plays a critical role in sequestering carbon emissions, capturing roughly a third of anthropogenic emissions since the industrial period. (DeVries, Global Biogeochemical Cycles, 2014. 28(7): p. 631-647). The concentration of carbon stored in the ocean is an order of magnitude higher than the amount in the atmosphere, (Adams and Caldeira, Elements, 2008. 4(5): p. 319-324) and as separation costs tend to scale with dilution, ocean capture presents an alternative to direct air capture (DAC). (House et al., Proc Natl Acad Sci USA, 2011. 108(51): p. 20428-33) Some naturally occurring forms of ocean capture already exist including coastal blue carbon (McLeod et al., Frontiers in Ecology and the Environment, 2011. 9(10): p. 552-560; Duarte, et al., Nature Climate Change, 2013. 3(11): p. 961-968) and carbon mineralization such as basalt capture (Snæbjörnsdóttir, S.Ó., et al., Nature Reviews Earth & Environment, 2020. 1(2): p. 90-102; Matter, J.M., et al., Science, 2016. 352(6291): p. 1312). In addition, coupling ocean capture with the generation of value-added products can offset the cost of carbon capture and provide an economic incentive for negative emissions. (Hepburn, et al., Nature, 2019. 575(7781): p. 87-97)

The pH swing approach leverages the ocean’s pH dependent CO₂-bicarbonate-carbonate equilibrium to remove dissolved inorganic carbon (DIC) from the ocean. As the dissolved CO₂ in at the ocean’s surface is in dynamic equilibrium with the CO₂ in the atmosphere, continuous DIC removal allows for the ocean to continuously uptake CO₂ from the air, thus, providing an alternative to direct air capture. Almost a decade ago, Eisaman et al. utilized the pH swing method to extract 59% of the total dissolved inorganic carbon from synthetic seawater as CO₂ with an electrochemical energy consumption of 242 kJ mol-1 (CO₂). (Eisaman, et al., Energy & Environmental Science, 2012. 5(6): p. 7346-7352) However, the CO₂ was removed as a gas stream, requiring further processing. Digdaya et al. combined a similar vacuum stripping process with electrochemical reduction, utilizing captured CO₂ and generating value-added chemicals from simulated seawater in the process. (Digdaya, et al., Nature Communications, 2020. 11(1): p. 4412) Despite these efforts, an improved method of removing carbon dioxide from seawater is needed.

### SUMMARY OF THE INVENTION

The invention is not intended to be limited by the specific embodiments disclosed herein, and any combination of these embodiments (or portions thereof) may be made to define further embodiments.

Disclosed herein is a system for removing carbon dioxide (CO₂) from seawater comprising: an electrodialysis flow cell comprising a bipolar membrane having an acidified seawater product stream with a pH less than or equal to 8.5, or, less than or equal to 8.3, or less than or equal to 8.1 and a basified seawater product stream with a pH greater than or equal to 9.0, or greater than or equal to 9.2, or greater than or equal to 9.3; a photobioreactor; and a microbially induced carbonate precipitation reactor; wherein the electrodialysis flow cell is in fluid communication with the photobioreactor via the acidified seawater product stream and in fluid communication with the microbially induced carbonate precipitation component via the basified seawater product stream.

In some embodiments, the electrodialysis flow cell comprises a first seawater channel adjacent to a first side of the bipolar membrane and a second seawater channel adjacent to a second side of the bipolar membrane, wherein the first side of the bipolar membrane is opposed to the second side of the bipolar membrane.

In some embodiments, the electrodialysis flow cell further comprises an anode, a cathode, an electrolyte circulation loop, a first cationic exchange membrane and a second cationic exchange membrane.

In some embodiments, the first cationic exchange membrane is located on a side of the first seawater channel opposite the bipolar membrane.

In some embodiments, the second cationic exchange membrane is located on a side of the second seawater channel opposite the bipolar membrane.

In some embodiments the electrolyte is disposed between the first cationic exchange membrane and the anode and between the second cationic exchange membrane and the cathode.

In some embodiments, the first seawater channel is in fluid communication with the basified seawater product stream and the second seawater channel is in fluid communication with the acidified seawater product stream.

In some embodiments, the system further comprises a solar driven electricity generating device.

In some embodiments, the system further comprises a wind driven electricity generating device.

In some embodiments, the photobioreactor comprises cyanobacteria.

Also disclosed herein is a method of removing carbon dioxide from seawater comprising passing seawater through a system as described above (and below).

In some embodiments the method may further comprise removing precipitated carbon dioxide.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are preferred. It should be understood, however, that the invention is not limited to the precise arrangements and instrumentalities of the embodiments shown in the drawings.

FIG. 1 is a block diagram of the system and associated method; and

FIGS. 2A and 2B are diagrams of the electrodialysis flow cell.

FIG. 3 is a process flow diagram of the claimed process.

### DETAILED DESCRIPTION

The invention can be understood more readily by reference to the following detailed description, examples, drawings, and claims, and their previous and following description. However, it is to be understood that this invention is not limited to the specific compositions, articles, devices, systems, and/or methods disclosed unless otherwise specified, and as such, of course, can vary. While aspects of the invention can be described and claimed in a particular statutory class, such as the composition of matter statutory class, this is for convenience only and one of skill in the art will understand that each aspect of the invention can be described and claimed in any statutory class.

It is to be understood that the figures and descriptions of the invention have been simplified to illustrate elements that are relevant for a clear understanding of the invention, while eliminating, for the purpose of clarity, many other elements found in electrodialysis flow cells and related systems. Those of ordinary skill in the art may recognize that other elements and/or steps are desirable and/or required in implementing the invention. However, because such elements and steps are well known in the art, and because they do not facilitate a better understanding of the invention, a discussion of such elements and steps is not provided herein. The disclosure herein is directed to all such variations and modifications to such elements and methods known to those skilled in the art.

While the invention is capable of being embodied in various forms, the description below of several embodiments is made with the understanding that the disclosure is to be considered as an exemplification of the invention, and is not intended to limit the invention to the specific embodiments illustrated. Headings are provided for convenience only and are not to be construed to limit the invention in any manner. Embodiments illustrated under any heading or in any portion of the disclosure may be combined with embodiments illustrated under the same or any other heading or other portion of the disclosure.

Any combination of the elements described herein in all possible variations thereof is encompassed by the invention unless otherwise indicated herein or otherwise clearly contradicted by context.

Unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. It is to be understood that both the foregoing general description and the following detailed description are exemplary and explanatory only and are not restrictive.

All publications mentioned herein are incorporated herein by reference to disclose and describe the methods and/or materials in connection with which the publications are cited.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the terms “optional” or “optionally” mean that the subsequently described event, condition, component, or circumstance may or may not occur, and that the description includes instances where said event, condition, component, or circumstance occurs and instances where it does not.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Further, for lists of ranges, including lists of lower preferable values and upper preferable values, unless otherwise stated, the range is intended to include the endpoints thereof, and any combination of values therein, including any minimum and any maximum values recited.

Disclosed herein is a system 10 and a method for removing carbon dioxide (CO₂) from seawater. The term “seawater”, as used herein is inclusive of naturally occurring seawater (removed from an ocean or similar body of water) and also synthetic seawater in which water from a source has been combined with other components such as sodium chloride and bicarbonate, to form a solution which has a chemical profile that is similar to naturally occurring seawater.

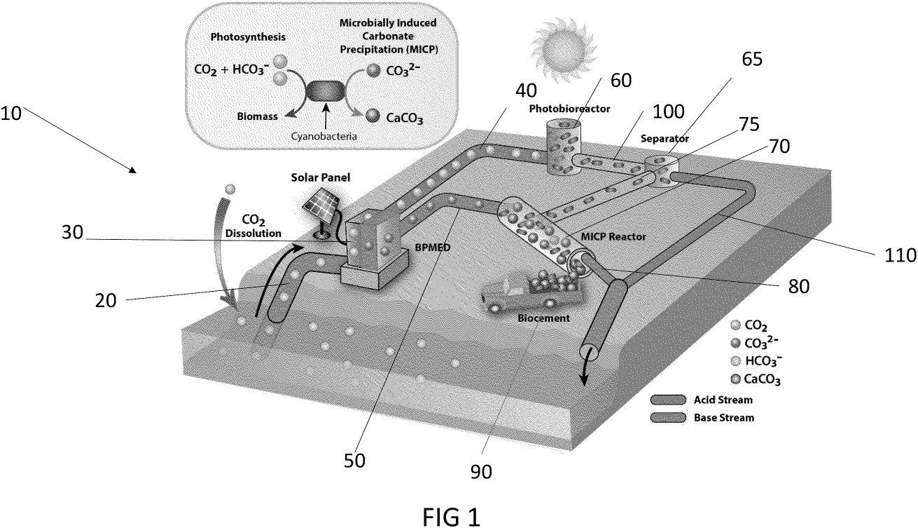

As shown in FIG. 1, seawater is introduced to an electrodialysis flow cell 30 having a bipolar membrane using a sea water inlet stream 20. The seawater is subjected to electrodialysis in the flow cell and two outlet streams, an acidified outlet stream 40 and a basified outlet stream 50 are produced. As discussed below the acidified outlet stream may have a pH less than or equal to 8.5, or less than or equal to 8.3, or less than or equal to 8.1. The basified outlet stream may have a pH greater than or equal to 9.0, or greater than or equal to 9.2, or greater than or equal to 9.3. The basified outlet stream enters microbially induced carbonate precipitation reactor 70 where carbonate is precipitated and collected. The acidified outlet stream enters a photobioreactor 60 where CO₂ is removed by cyanobacteria as part of cyanobacteria cultivation. The outlet stream 100 from the photobioreactor proceeds to a separator 65 which concentrates the cyanobacteria in a cyanobacteria stream 75 and provides cyanobacteria to the microbially induced carbonate precipitation reactor 70. Residual acid stream 110 leaves the separator 65 and may be combined with the outlet stream 80 before being returned to the seawater. Precipitated carbonate leaves the microbially induced carbonate precipitation unit 70 via carbonate stream 90. The precipitated carbonate may be filtered, centrifuged or any other appropriate separation method. The separation method may be part of the microbially induced carbonate precipitation unit 70 or may occur in a separate unit. Seawater leaves the microbially induced carbonate precipitation unit 70 via outlet stream 80 and is returned to the ocean. If needed the seawater may be treated to establish a desired pH prior to being returned to the ocean.

Carbon dioxide is primarily present in seawater as HCO₃⁻. Electrochemical methods of ocean carbon removal can be characterized into acidic or alkaline capture, depending on the removal method. At lower pH, soluble carbonate and bicarbonate is converted into dissolved gaseous carbon dioxide (Equation 1a,1b), which can be stripped.

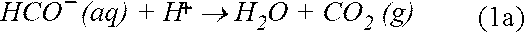

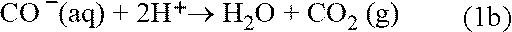

Conversely, at higher pH there is a supersaturation of dissolved carbonate species, and carbon capture may be facilitated through the precipitation of calcium carbonates (Equation 2), magnesium carbonates, dolomite, and silicate minerals. (Renforth, P. and G. Henderson, Reviews of Geophysics, 2017. 55(3): p. 636-674; Mucci, A., Am. J. Sci, 1983. 283(7): p. 780-799; Kline, W.D., Journal of the American Chemical Society, 1929. 51(7): p. 2093-2097; Bénézeth, P., et al., C. Geochimica et Cosmochimica Acta, 2018. 224: p. 262-275; Stefánsson, A., Chemical Geology, 2001. 172(3-4): p. 225-250) . The driving force of calcium carbonate precipitation has a strong dependance on pH. However, calcium carbonate precipitation is kinetically and economically challenging even though untreated seawater is supersaturated with carbonate species by a factor of 2 (Spanos and Koutsoukos, The Journal of Physical Chemistry B, 1998. 102(34): p. 6679-6684; Cao et al., Geophysical Research Letters, 2007. 34(5)). Thus is due to the presence of other dissolved chemical species (i.e., Mg²⁺, SO₄²⁻, and inorganic phosphates) in the ocean, which inhibit spontaneous inorganic calcium carbonate precipitation and growth. (Nielsen, M., et al., Crystal Growth & Design, 2016. 16(11): p. 6199-6207.; Morse, J.W., R.S. Arvidson, and A. Lüttge, Chemical reviews, 2007. 107(2): p. 342-381.; Pytkowicz, R., American Journal of Science, 1973. 273(6): p. 515-522.; Pytkowicz, R.M., The Journal of Geology, 1965. 73(1): p. 196-199.)

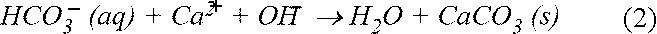

Combining acidic and alkaline capture presents a unique opportunity to harness the merits of both gaseous CO₂ stripping and carbonate precipitation while overcoming the individual limitations of both. This hybrid approach can benefit from engineering solutions such as optimizing the pH of seawater via electrodialysis with a bipolar membrane, which results in the generation of two outlet streams, a basified outlet stream and an acidified outlet stream and optimized for simultaneous acidic and basic carbon capture.

Bipolar membranes (BPMs) consist of an anion exchange layer (AEL) in contact with a cation exchange layer (CEL). The AEL material has fixed cationic groups, which interact with mobile anions electrostatically; and vice versa for the CEL. The junction of these two layers is known as the interfacial layer (IF) where water dissociation or H⁺/OH⁻ recombination, can occur, depending on the applied bias. During electrodialysis, the electric field produced from the applied potential drives H⁺ ions produced from water dissociation away from the IF through the CEL. At the same time, OH⁻ ions are driven through the AEL, creating a steady-state pH difference across the membrane. (Oener et al., Science, 2020: p. eaaz1487) To accelerate the water dissociation, catalysts can be incorporated into IF. (Oener et al., Science, 2020: p. eaaz1487) The ability to simultaneously generate an acidic and basic environment makes BPM electrodialysis (BPMED) cells ideal systems for subsequent acidic or alkaline carbon capture methods. In the past, BPMs have been configured to take advantage of hydrogen and oxygen evolution reactions at cathode and anode, respectively and produce hydrogen fuel to offset operating costs. (Willauer et al., Ind. Eng. Chem. Res., 2011. 50: p. 9876) However, these systems are constrained by substantial overpotentials required to drive the necessary current. Thus, utilizing reversible redox-couple solutions in the electrode chambers can be used to optimize the energetics of water dissociation, reducing overall energy consumption for CO₂ removal, at the cost of hydrogen generation. (Digdaya et al., Nature Communications, 2020. 11(1): p. 4412)

As degradation and material stability can be the limiting parameter, developing novel strategies to prevent or reverse degradation is imperative for the utilization of BPMs in CO₂ capture and storage applications. BPM systems that rely on carbonate precipitation face the issue of cathodic carbonate precipitation that can impact cell performance. (Rau, Environmental Science & Technology, 2008. 42(23): p. 8935-8940) Continuous mineral build-up may also lead to membrane fouling and scaling, increasing membrane resistance and consequently energy consumption. (Wang and Cong, Separation and purification technology, 2011. 79(1): p. 103-113) Both issues necessitate eventual electrode/membrane removal and replacement, increasing the operating costs of a scaled BPMED system. The implementing of polarity reversal to dissolve carbonate scales may be employed to help mitigate this issue. (Willauer et al., Industrial & Engineering Chemistry Research, 2014. 53(31): p. 12192-12200; Lee, H.-J., M.-K. Hong, and S.-H. Moon, Desalination, 2012. 284: p. 221-227) Hydrophobic coating or modifying the membrane’s surface charge has been investigated as another way to mitigate fouling and scaling. For example, the use of ultra-thin TiO₂, on the order of a single nanometer, has been demonstrated to resist to chemical corrosion without damaging the membrane structure and functionality. (Zhou et al., Environmental science & technology, 2018. 52(24): p. 14311-14320) However, scaling at either the electrode and membrane should not be of concern in this system. First, the implementation of reversible redox-couple solutions prevents precipitation at the electrode as the seawater is not in direct contact with the electrodes. Second, the primary mechanism of carbonate precipitation is indirect through MICP rather than direct pH swing, which allows for a temporal separation of membrane contact and precipitation.

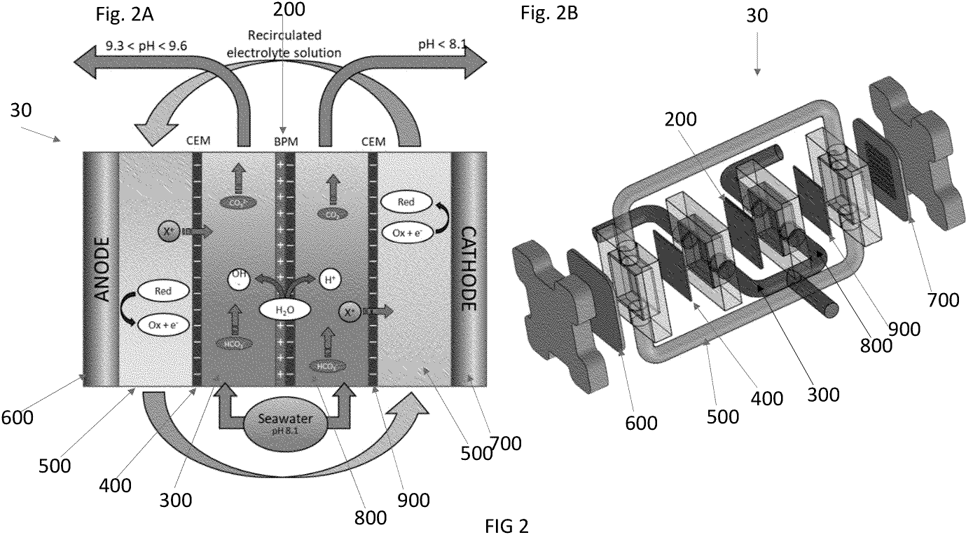

In certain embodiments electrodialysis flow cell 30 of FIG. 1 is a four-compartment electrodialysis flow cell to generate acidified and basified streams from natural seawater, as is further illustrated in FIG. 2. Electricity may be provided to the electrodialysis flow cell by any appropriate source. Advantageously, a solar-driven electricity generating device, a wind driven electricity generating device or a combination thereof (not shown) may be used. In some embodiments, the electricity generating device comprises an energy storage device for continued operation if the electricity generating device is unable to satisfy the demands of the system. Energy storage devices include, but are not limited to, capacitors, supercapacitors, batteries, hydrogen storage systems, compressed air systems, pumped hydro systems, cryogenic energy storage systems, and superconducting magnetic energy storage systems. FIG. 2A is a schematic view of the electrodialysis flow cell 30 and FIG. 2B is an exploded view of the same cell.

As shown in FIG. 2A, electrodialysis flow cell 30 includes a bipolar membrane 200, a first seawater channel 300 adjacent to and in contact with a first side of bipolar membrane 200. First seawater channel 30 also contacts one side of first cationic exchange membrane 400. Electrolyte 500 contacts an opposing side of cationic exchange membrane 400. Anode 600 and cathode 700 are also in contact with electrolyte 500. A second side of bipolar membrane 200, opposite to the first side, is in contact with second seawater channel 800. Second seawater channel 800 also contacts one side of second cationic exchange membrane 900. Electrolyte 500 contacts a second side of cationic exchange membrane 900, opposite to the first side. Electrolyte 500 is located in a circulation loop as shown in FIG. 2B.

The electrolyte solution 500 is circulated between the two outer chambers. The two outer chambers that contain electrolyte 500 are separated from the seawater chambers by cation exchange membranes, 400, 900. The redox reactions of electrolyte occur at cathode 700 and anode 600 to enhance the bipolar membrane 200 efficiency. Seawater is collected and sent into two channels 300, 800 separated by the bipolar membrane 200. When a potential is applied, H+ and OH- migrate across the cation exchange layer and anion exchange layer of the bipolar membrane, respectively, and the simultaneous acidification and basification of seawater is achieved. Given, that the rate of water dissociation is proportional to the potential applied, varying the applied potential, and subsequently the electrical current, allows the resulting pH of the seawater leaving the electrodialysis flow cell to be electrochemically tunable (Digdaya, et al., Nature Communications, 2020. 11(1): p. 4412). The pH of the acidified and basified seawater streams may be tuned individually by having natural seawater enter the two sea water chambers at different volumetric flow rates. At a given applied potential, adjusting the flowrate of the input stream modifies the residence time of seawater in the BPMED flow cell, effectively concentrating or diluting the of H+ and OH- in the outlet acid and base streams. Modifying the applied potential and seawater flowrates not only allows for real-time tunability of operating conditions, but also potentially allow for energy optimization between size and total energy consumption (due to pumping and electrochemical energy input). The pH-manipulated streams then leave the flow cell separately for cyanobacteria growth and later MICP.

Lowering the pH of seawater pushes the chemical equilibrium of CO₂ towards dissolved carbon dioxide. The acidic outlet stream with dissolved CO₂ is an excellent environment for culturing photosynthetic cyanobacteria while simultaneously fixing CO₂. (Digdaya, et al., Nature Communications, 2020. 11(1): p. 4412) The cyanobacteria from the acidified outlet stream, 40, passes to a photobioreactor 60 for growth. Cyanobacteria can fix dissolved inorganic carbon by either dissolved CO₂ or HCO₃⁻ ion uptake. Cyanobacteria are a diverse group of phototrophic prokaryotic marine microorganisms that are significant contributors to marine primary production. Dense cyanobacterial blooms are known to rapidly deplete dissolved CO₂ concentrations in eutrophic surface waters. (Ji et al., Journal of experimental botany, 2017. 68(14): p. 3815-3828)

While some photobioreactors configurations can be scaled for industrial cyanobacterial growth, challenges pertaining to light/nutrient distribution and utilization may place an upper limit on culture density for a given reactor. (Yadav, and Sen, Journal of CO₂ Utilization, 2017. 17: p. 188-206; Kumar, et al., Bioresource Technology, 2011. 102(8): p. 4945-4953; Johnson, et al., Biotechnology Progress, 2018. 34(4): p. 811-827) Furthermore, artificial light operation is a key contributor to the operating cost of photobioreactors. (Johnson, et al., Biotechnology Progress, 2018. 34(4): p. 811-827) The photobioreactors may have a design that improves resource distribution/utilization and minimizes lighting costs.

Between a pH of 8-10 CaCO₃, MgCO₃, and Mg(OH)₂ are able to precipitate. (Wang, et al., Industrial & Engineering Chemistry Research, 2011. 50(13): p. 8333-8339) To maximize carbonate precipitation, the basified outlet stream 50 has a pH of 9.3-9.6 range to prevent significant Mg(OH)₂ precipitation. (de Lannoy, et al., International Journal of Greenhouse Gas Control, 2018. 70: p. 243-253) The basified outlet stream, 50, passes to unit 70 for MICP using the cyanobacteria previously grown in the photobioreactor. (Achal and Mukherjee, Construction and Building Materials, 2015. 93: p. 1224-1235; Achal et al., Earth-Science Reviews, 2015. 148: p. 1-17) The precipitated product, “biocement”, may be separated from the basic seawater stream via filtration, centrifugation or other applicable method. (Achal et al., Earth-Science Reviews, 2015. 148: p. 1-17)

Microbially induced carbonate precipitation (MICP) is a method of accelerating carbonate precipitation by introducing biological or naturally derived nucleation seeds. (Castro-Alonso et al., Frontiers in Materials, 2019. 6: p. 126) The predominate mechanisms of action are not known and it is speculated that the mechanisms can: 1) involve cellular metabolism where negatively charged byproducts are excreted from the cell, introducing a locally alkaline environment or 2) be independent of metabolism where the electrostatics of a negatively charged cell membrane can attract positively charged calcium ions, creating a local driving force.

Microbially induced carbonate precipitation (MICP) is controlled by four key factors: calcium concentration, dissolved inorganic carbon (DIC) concentrations, pH, and the availability of nucleation sites. Micro-organisms have net negative surfaces charges that attract calcium ions, making them ideal nucleation and precipitation sites. (Vahabi et al., Journal of Basic Microbiology, 2013. 55) Alkalization, which shifts local dissolved inorganic carbon to exist predominately as CO₃²⁻, and the attraction of Ca²⁺ ions to the negatively charged cell surface, increases Ω_{CaCO3} in the surrounding solution layer of the cell, catalyzing CaCO₃ precipitation. (Kamennaya, et al., Minerals, 2012. 2(4): p. 338-364.)

The process and system disclosed herein combines the merits of microbially induced carbonate precipitation with the pH control afforded by an efficient bipolar membrane system which allows CO₂ to be dually extracted from an acidified and basified medium, while simultaneously generating a product. The process and system employs two parts which separate organic growth from inorganic carbonate precipitation. In doing so, a CO₂ negative process has been developed.

The method and system described herein has several economic advantages compared to previously proposed electrochemical methods of ocean carbon removal. Unlike previous pH-swing methods that rely solely on the acidified or basified seawater for carbon removal, our system utilizes both acidic and alkaline CO₂ capture The use of natural-occurring organisms leads to unique advantages. For acidic capture, where membrane contactors are typically used to degas and strip CO₂, cyanobacteria act a natural membrane contactor that consumes concentrated CO₂ spontaneously without need for degas pre-treatment nor electrical input. This avoids the use of upwards of 1340 m²/tCO₂ per day of membrane contactors. For alkaline capture, bipolar membranes have demonstrated the ability to generate alkalinity at a fraction of the cost. Operating costs can be potentially further offset via its end product, i.e., carbonate-encapsulated biocement. Combining these two strategies can greatly reduce the cost of alkaline ocean capture. Operating costs can be potentially offset via its carbonate-encapsulated cyanobacteria biocement end product, which can the sold for concrete self-healing properties. Microbially induced calcium carbonate precipitation has been demonstrated to improve the strength and durability of cementitious materials, concrete self-repair, and crack sealing. (Achal and Mukherjee, Construction and Building Materials, 2015. 93: p. 1224-1235; De Muynck, et al., Cement and concrete Research, 2008. 38(7): p. 1005-1014; Ramachandran, et al., ACI Materials Journal-American Concrete Institute, 2001. 98(1): p. 3-9) Cement production accounts for 5-7% of global anthropogenic emissions while concurrently increasing by 2-4% yearly. Zhang, et al., Journal of Cleaner Production, 2018. 184: p. 451-465; van Ruijven, et al., Resources, Conservation and Recycling, 2016. 112: p. 15-36) Therefore, being able to produce carbon-negative building materials opens a route to reduce an anthropogenic CO₂ emission stemming from construction.

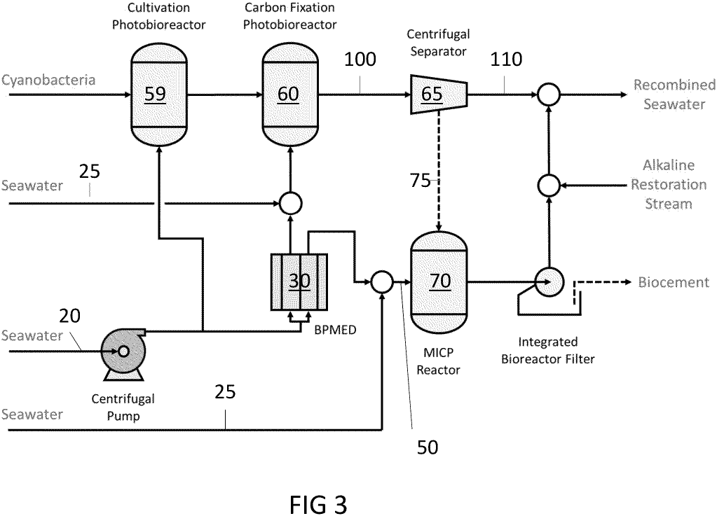

An additional embodiment of a system is shown in FIG. 3. The system in FIG. 3 differs from system 10 shown in FIG. 1 in that the electrodialysis flow cell 30 having a bipolar membrane produces a concentrated acid outlet stream and a concentrated basic outlet stream which is then diluted with sea water to achieve the desired pH levels for the photobioreactor and the MICP reactor. Additionally, the system shown in FIG. 3 includes a cultivation photobioreactor in addition to the carbon fixation photobioreactor. A cultivation photobioreactor may be useful for slower growing cyanobacteria in order to increase the productivity of the system.

It is also contemplated that it may be useful to combine the outlet stream carbon capture system as described herein with the waste product of a desalination plant. By combining the two outlet streams (waste streams) a more balanced flow can be returned to the ocean, with a balance of minerals, ions and pH that are closer to the composition of bulk seawater which will minimize the negative impact of sea water carbon capture on marine life.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A system for removing carbon dioxide (CO₂) from seawater comprising:
an electrodialysis flow cell comprising a bipolar membrane having an acidified seawater product stream with a pH less than or equal to 8.5 and a basified seawater product stream with a pH greater than or equal to 9.0;
a photobioreactor; and
a microbially induced carbonate precipitation reactor; wherein the electrodialysis flow cell is in fluid communication with the photobioreactor via the acidified seawater product stream and in fluid communication with the microbially induced carbonate precipitation component via the basified seawater product stream.

2. The system of claim 1, wherein the pH of the basified water is between about 9.3 and about 9.6.

3. The system of claim 1, wherein the pH of the acidified water is less than about 8.1.

4. The system of claim 1, wherein the electrodialysis flow cell comprises a first seawater channel adjacent to a first side of the bipolar membrane and a second seawater channel adjacent to a second side of the bipolar membrane, wherein the first side of the bipolar membrane is opposed to the second side of the bipolar membrane.

5. The system of claim 1, wherein the electrodialysis flow cell further comprises an anode, a cathode, an electrolyte circulation loop, a first cationic exchange membrane and a second cationic exchange membrane.

6. The system of claim 5, wherein the first cationic exchange membrane is located on a side of the first seawater channel opposing the bipolar membrane.

7. The system of claim 5, wherein the second cationic exchange membrane is located on a side of the second seawater channel opposing the bipolar membrane.

8. The system of claim 5, wherein the electrolyte is disposed between the first cationic exchange membrane and the anode and between the second cationic exchange membrane and the cathode.

9. The system of claim 4, wherein the first seawater channel is in fluid communication with acidified seawater product stream and the second seawater channel is in fluid communication with the basified seawater product stream.

10. The system of claim 1 further comprising a solar driven electricity generating device.

11. The system of claim 1 further comprising a wind driven electricity generating device.

12. The system of claim 10, wherein the electricity generating device further comprises an energy storage device.

13. The system of claim 1, wherein the photobioreactor comprises cyanobacteria.

14. The system of claim 1, wherein the outflow of the photobioreactor is recombined with seawater.

15. The system of claim 14, wherein the outflow of the photobioreactor is centrifuged to separate the bacteria from the outflow before allowing it to be recombined with seawater.

16. The system of claim 15, wherein the bacteria retained in the centrifugation are introduced into the microbially induced carbonate precipitation component.

17. The system of claim 1, wherein the outflow of the microbially induced carbonate precipitation component is mixed with the outflow of the photobioreactor before it is recombined with seawater.

18. The system of claim 1, wherein the photobioreactor is in fluid communication with the microbially induced carbonate precipitation component.

19. A method of removing carbon dioxide from seawater comprising passing seawater through a system according to claim 1.

20. The method of claim 19, further comprising removing precipitated carbon dioxide.
